(19) United States
(12) Patent Application Publication
(10) Pub. No.: US 2018/0314683 A1
(43) Pub. Date: Nov. 1, 2018

(54) METHOD AND DEVICE FOR PROCESSING NATURAL LANGUAGE

(71) Applicant: MediaTek Singapore Pte. Ltd., Singapore (SG)

(72) Inventors: Qilin TAN, Chengdu City (CN); Fuchuan LUO, Chengdu City (CN); Pingshui LI, Chengdu City (CN); Qiankun XIE, Chengdu City (CN)

(21) Appl. No.: 15/962,372

(22) Filed: Apr. 25, 2018

(30) Foreign Application Priority Data
Apr. 27, 2017 (CN) 201710287849.5

(51) Int. Cl. G06F 17/27; G06F 17/30; G06F 17/28

(52) U.S. Cl. CPC G06F 17/2705; G06F 17/30687; G06F 17/30696; G06F 17/28; G06F 17/30613

(57) ABSTRACT

A method for processing a natural language is provided. The method is used in an electronic device and includes: receiving a natural language input from a user via a client device; determining whether the natural language input matches a rule in a database; translating the natural language input into an intermediate code corresponding to the natural language input when the natural language input matches the rule; and compiling the intermediate code and generating an operation script code corresponding to the intermediate code.

### CROSS REFERENCE TO RELATED APPLICATIONS

The present application is based on, and claims priority from, China Patent Application No. 201710287849.5, filed on Apr. 27, 2017, the disclosure of which is hereby incorporated by reference herein in its entirety.

### BACKGROUND OF THE INVENTION

### Field of the Invention

The invention relates to the field of computers. More specifically, the present invention relates to a method and a device for processing natural language.

### Description of the Related Art

Software testing is used to determine whether a particular software application works as expected. Test techniques include, but are not limited to, the process of executing a program or application in a controlled environment. Such testing is conducted with the intent of finding errors, flaws, mistakes, etc. in the software application.

However, in the prior art, it is necessary to write a test case when performing a software test. A general test case consists of a plurality of test steps. Users cannot know whether the test case is written correctly when writing the test case. When the test case needs to be modified, the user has to modify all the steps involved in the test case.

Therefore, the process of generating test cases in the prior art is very tedious, time consuming and inefficient.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method and a device for processing natural language are provided.

In a preferred embodiment, a method for processing natural language is provided in the invention. The method is used in an electronic device, and comprises: receiving a natural language input from a user via a client device; determining whether the natural language input matches a rule in a database; translating the natural language input into an intermediate code corresponding to the natural language input when the natural language input matches the rule; and compiling the intermediate code and generating an operation script code corresponding to the intermediate code.

In a preferred embodiment, a device for processing natural language is provided in the invention. The device comprises a processor and a memory. The memory is coupled to the processor. The processor is configured to execute program codes stored in the memory to: receive a natural language input from a user via a client device; determine whether the natural language input matches a rule in a database; translate the natural language input into an intermediate code corresponding to the natural language input when the natural language input matches the rule; and compile the intermediate code and generate an operation script code corresponding to the intermediate code.

### BRIEF DESCRIPTION OF DRAWINGS

The accompanying drawings are included to provide a further understanding of the invention, and are incorporated in and constitute a part of the present invention. The drawings illustrate implementations of the invention and, together with the description, serve to explain the principles of the invention. It should be appreciated that the drawings are not necessarily to scale as some components may be shown out of proportion to the size in actual implementation in order to clearly illustrate the concept of the present invention.

FIG. 1 shows a schematic diagram illustrating a system for processing a natural language in accordance with one embodiment of the invention.

FIG. 2 shows an alternative simplified functional block diagram of an electronic device according to one embodiment of the present invention.

FIG. 3 is a flow diagram illustrating a method for processing a natural language according to an embodiment of the present invention with reference to FIG. 1.

FIGS. 4A-4B show a screen illustrating the user enters the natural language input and the NLP server translates the natural language into the operation script code according to an embodiment of the present invention.

FIG. 5 is a schematic diagram illustrating the user enters the natural language input and the NLP server displays the sentences according to an embodiment of the present invention.

FIG. 6 is a schematic diagram illustrating the user enters the natural language input and the NLP server displays the sentences according to an embodiment of the present invention.

FIG. 7 is a schematic flow diagram of a method illustrating the NLP server processing high-level instructions defined by the user according to an embodiment of the present invention.

FIG. 8 shows a screen provided by the NLP server for the user to enter the high-level instructions according to an embodiment of the present invention.

FIG. 9 is a schematic diagram illustrating the user querying the high-level instruction by entering the keywords according to an embodiment of the present invention.

### DETAILED DESCRIPTION OF THE INVENTION

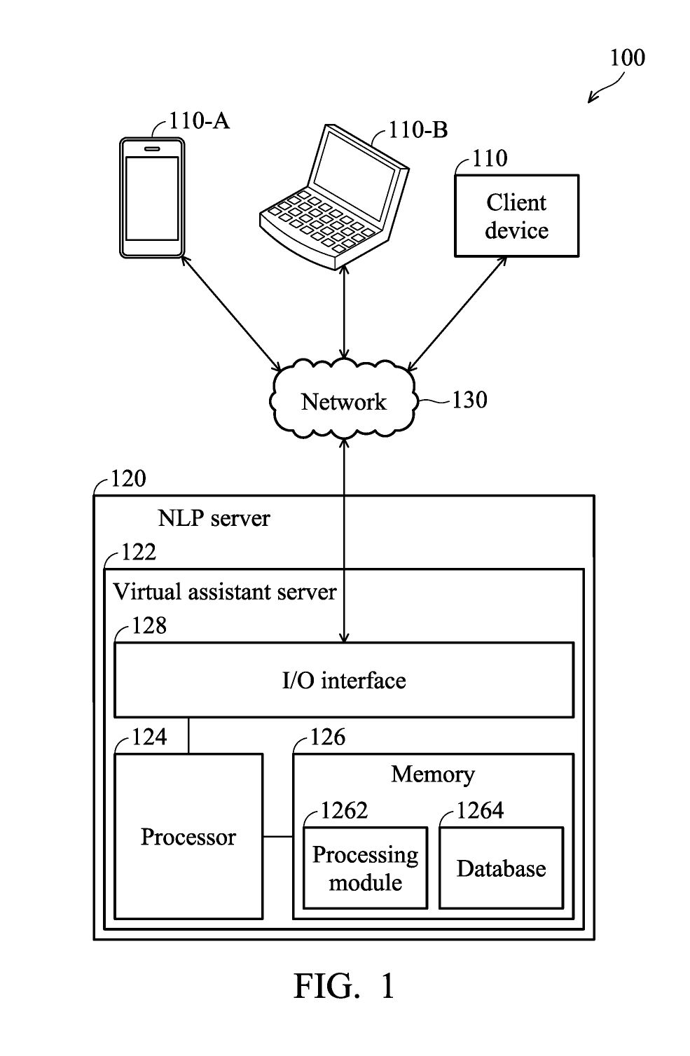

Several exemplary embodiments of the present disclosure are described with reference to FIGS. 1 through 9 which generally relate to a method and a device for processing natural language. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

Certain terms are used throughout the description and following claims to refer to particular components. As one skilled in the art will appreciate, manufacturers may refer to a component by different names. The description does not intend to distinguish between components that differ in name but not function. In the following description and in the claims, the terms “include” and “comprise” are used in an open-ended fashion, and thus should be interpreted to mean “include, but not limited to”. Also, the term “couple” is intended to mean either an indirect or direct electrical connection. Thus, if a first device is coupled to a second device, that connection may be through a direct electrical connection, or through an indirect electrical connection via other devices and connections. The term “application” as used herein is intended to encompass executable and non-executable software files, raw data, aggregated data, patches, and other code segments. The term “exemplary” means that the disclosed element or embodiment is only an example, and does not indicate any preference of user. Further, like numerals refer to like elements throughout the several views, and the articles “a” and “the” includes plural references, unless otherwise specified in the description.

FIG. 1 shows a schematic diagram illustrating a system 100 for processing a natural language in accordance with one embodiment of the invention.

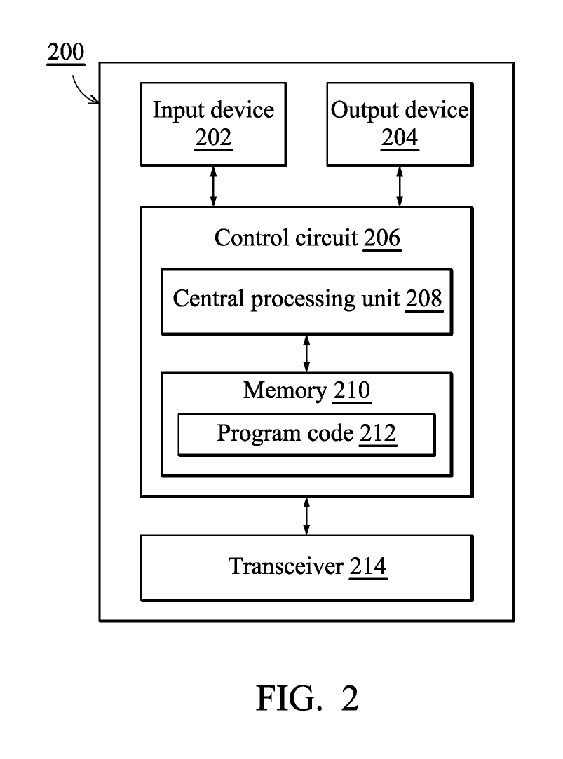

As shown in FIG. 1, in some embodiments, the system 100 can be implemented according to a client-server model. The system 100 can include a client-side portion executed on a client device 110, and a server-side portion executed on a natural language processing (NLP) server 120. The client device 110 can include any electronic device, such as a mobile phone 110-A, tablet computer 110-B, portable media player, desktop computer, laptop computer, personal digital assistant (PDA), wearable electronic device, or the like, and can communicate with the NLP server 120 through a network 130. The network 130 can include the Internet, an intranet, or any other wired or wireless public or private network. A detailed description of the client device 110 is provided below with reference to FIG. 2.

The client device 110 can provide client-side functionalities, such as user input and output processing and communications with the NLP server 120. The NLP server 120 can provide server-side functionalities for each client device 110.

The NLP server 120 can include one or more virtual assistant servers 122. As shown in FIG. 1, the virtual assistant server 122 includes one or more processors 124, a memory 126, an I/O interface 128 that can communicate with the client device. The various components of the virtual assistant server 122 can be coupled together by one or more communication buses or signal lines. The memory 126, or the computer-readable storage media of the memory 126, can include one or more processing modules 1262 and database 1264. The one or more processing modules 1262 can include various programs and instructions. The one or more processors 124 can execute the programs and instructions of the one or more processing modules 1262 and read/write to/from the database 1264. In the context of the invention, a “non-transitory computer-readable storage medium” can be any medium that can contain or store the program for use by or in connection with the instruction execution system, apparatus, or device.

In some embodiments, the one or more processing modules 1262 can include various programs and instructions for performing various aspects of natural language processing. One or more databases 1264 may include various user data that can be accessed or referenced when performing various aspects of natural language processing, such as natural language inputs (words, sentences, etc.) entered by the user. The database 1264 may also store predefined rules, such as, the grammatical relations between the sentences. For example, the rule is used to define that a verb and a verb cannot be connected together, or whether the sentence conforms to the grammatical relations between the sentences and so on. Therefore, when the natural language input received by the NLP server 120 is “click enter”, the NLP server 120 determines that the natural language input does not conform to the rule since both “click” and “enter” are verbs. In another embodiment, the NLP server 120 may also use a language tool to check whether the syntax of the natural language input conforms to one of the rules.

The NLP server 120 may be implemented on one or more standalone data processing devices or a distributed network of computers. In some embodiments, the NLP server 120 may employ various virtual devices and/or services of third-party service providers (e.g., third-party cloud service providers) to provide the underlying computing resources and/or infrastructure resources of the NLP server 120.

FIG. 2 shows an alternative simplified functional block diagram of an electronic device 200 according to one embodiment of the present invention. As shown in FIG. 2, the electronic device 200 can be utilized for realizing the client device 110. The electronic device 200 may include an input device 202, an output device 204, a control circuit 206, a central processing unit (CPU) 208, a memory 210, a program code 212, and a transceiver 214. The control circuit 206 executes the program code 212 in the memory 210 through the CPU 208, thereby controlling the operation of the electronic device 200. The electronic device 200 can receive signals input by a user through the input device 202, such as a keyboard or keypad, and can output images and sound through the output device 304, such as a monitor or speakers. The transceiver 214 is used to receive and transmit wireless signals wirelessly, deliver received signals to the control circuit 206, and output signals generated by the control circuit 206.

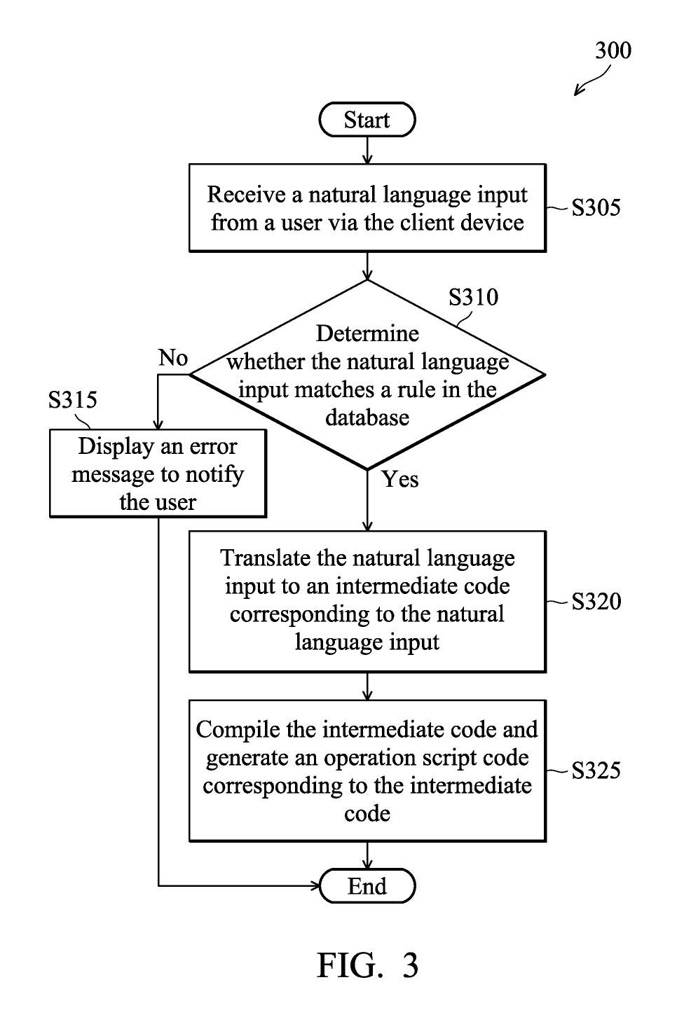

FIG. 3 is a flow diagram illustrating a method 300 for processing a natural language according to an embodiment of the present invention with reference to FIG. 1.

In step S305, the NLP server receives a natural language input from a user via the client device. Next, in step S310, the NLP server determines whether the natural language input matches a rule in the database. When the NLP server determines that the natural language input does not match the rule in the database (“No” in step S310), in step S315, the NLP server displays an error message to notify the user.

When the NLP server determines that the natural language input matches the rule in the database (“Yes” in step S310), in step S320, the NLP server translates the natural language input to an intermediate code corresponding to the natural language input. For example, the NLP server may parse the natural language input (e.g., tagging part of speech, type dependence, coreference analysis, and/or entity recognition) to obtain a syntax tree corresponding to the natural language input. The NLP server translates the natural language input into the intermediate code according to the syntax tree and the data in the database. In step S325, the NLP server compiles the intermediate code and generates an operation script code corresponding to the intermediate code, wherein the operation script code can be executed in an Android operating system. In an embodiment, the operation script code can be an Easy Script. In another embodiment, the operation script code can have a variety of types for applying in the Android operating system.

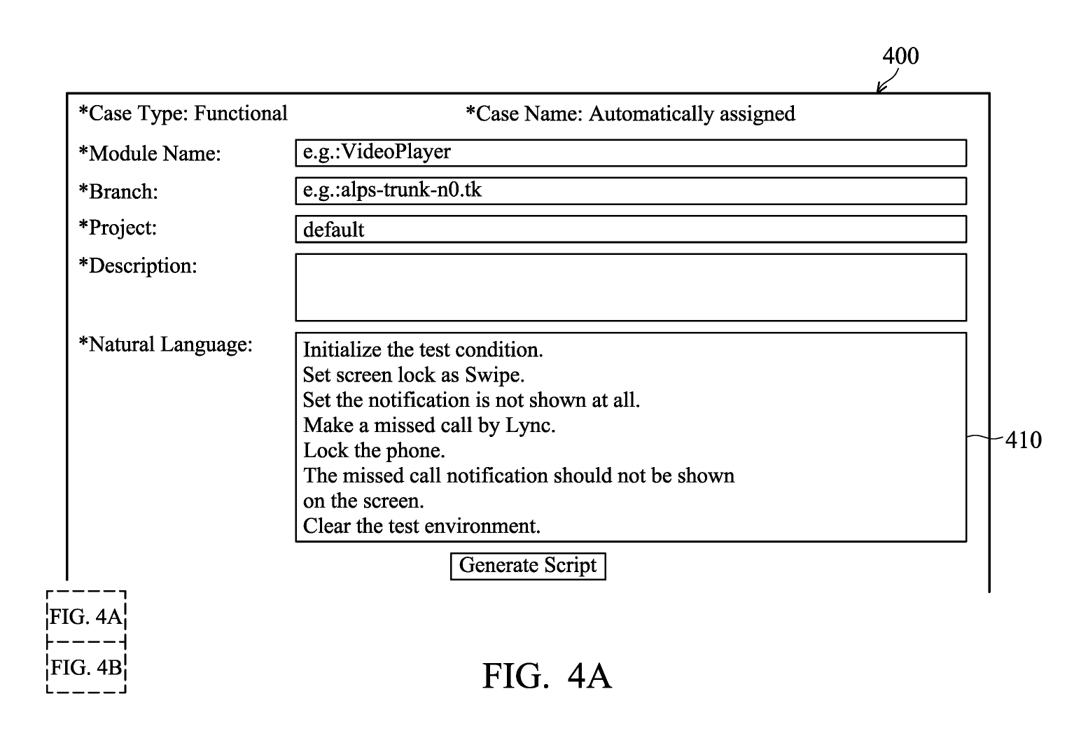

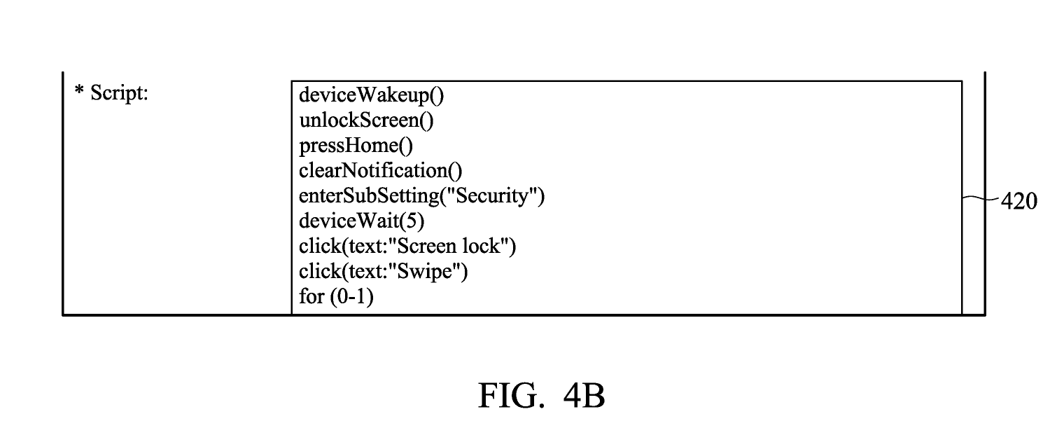

FIGS. 4A-4B show a screen 400 illustrating the user enters the natural language input and the NLP server translates the natural language into the operation script code according to an embodiment of the present invention. As shown in FIGS. 4A-4B, the user may enter a natural language in a natural language field 410. The NLP server translates the natural language input into the operation script code and displays the operation script code in the script field 420 after receiving the natural language input.

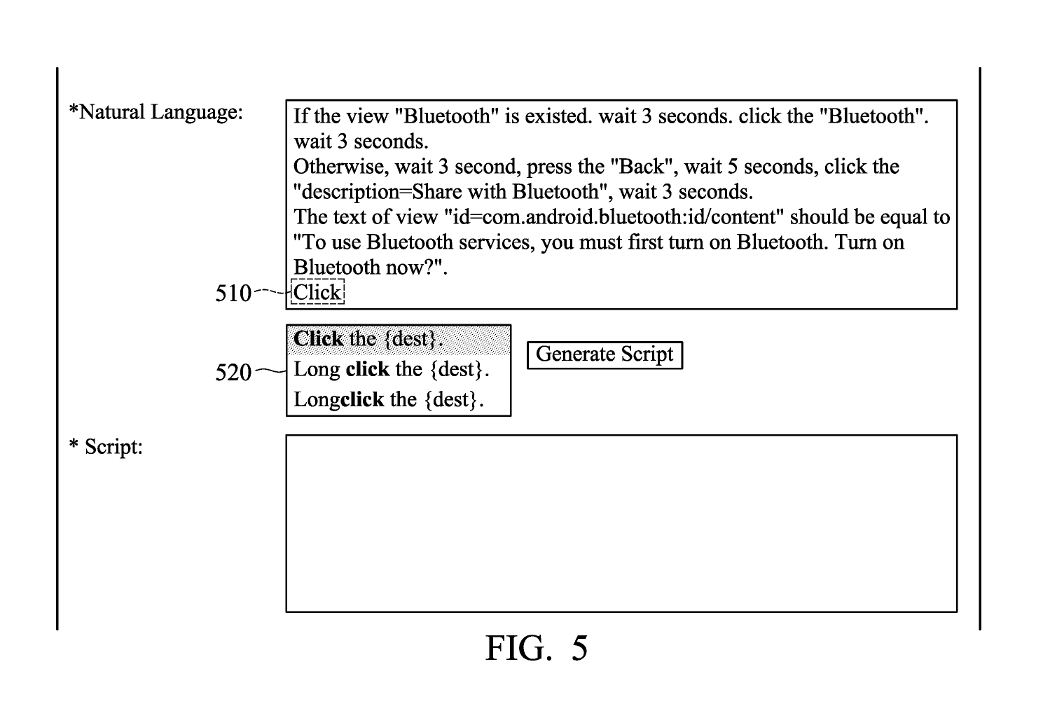

In addition, when the NLP server receives the natural language input from the user via the client device, the NLP server may further predicts the next input by the user according to the existing natural language inputs stored in the database. In an embodiment, when the natural language input entered by the user via the client device is a single word, the NLP server may query whether at least one sentence including the word is stored in the database according to the word. As shown in FIG. 5, it is assumed that the natural language input entered by the user is the word “Click” 510. The NLP server then queries whether at least one sentence including “Click” is stored in the database according to the word “Click”. When there is a sentence including “Click” stored in the database, the NLP server displays the sentence(s) 520 to prompt the user.

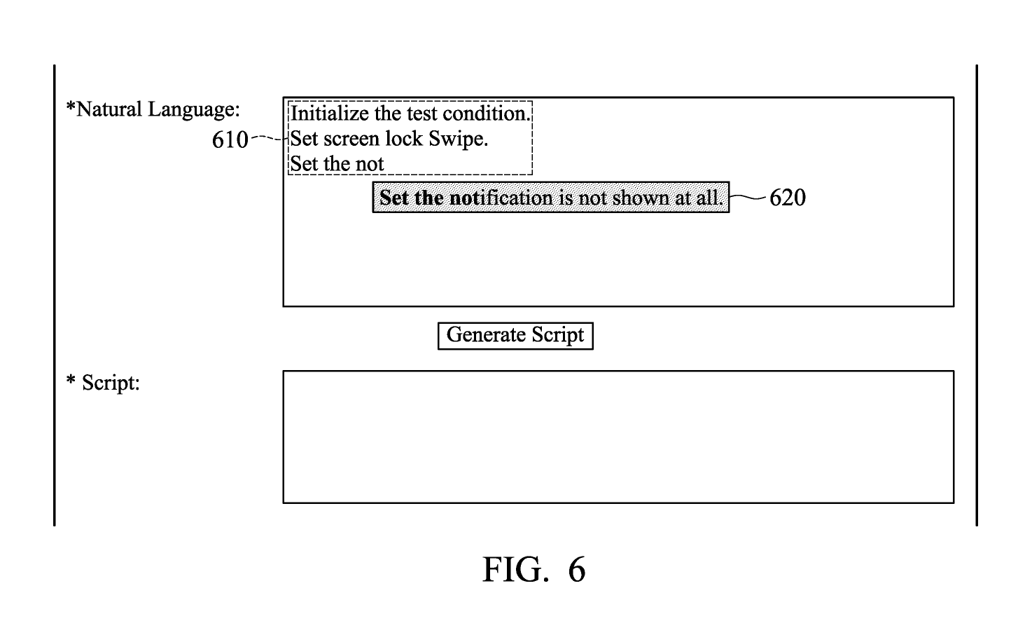

In another embodiment, when the natural language input entered by the user via the client device is a text composed of one or more sentences, the NLP server may query whether at least one sentence included in the text is stored in the database. The NLP server can calculate the probability of occurrence of each sentence when the sentences are stored in the database, and displays a first sentence with the highest probability to prompt the user. As shown in FIG. 6, when the natural language input entered by the user is the text “Initialize the test condition. Set screen lock Swipe. Set the not” 610, the NLP server queries whether at least one sentence included in the text is stored in the database according to the text “Initialize the test condition. Set screen lock Swipe. Set the not”. The NLP server calculates the probability of occurrence of each sentence and displays the first sentence 620 “Set the notification is not shown at all” with the highest probability to prompt the user when the sentences are stored in the database.

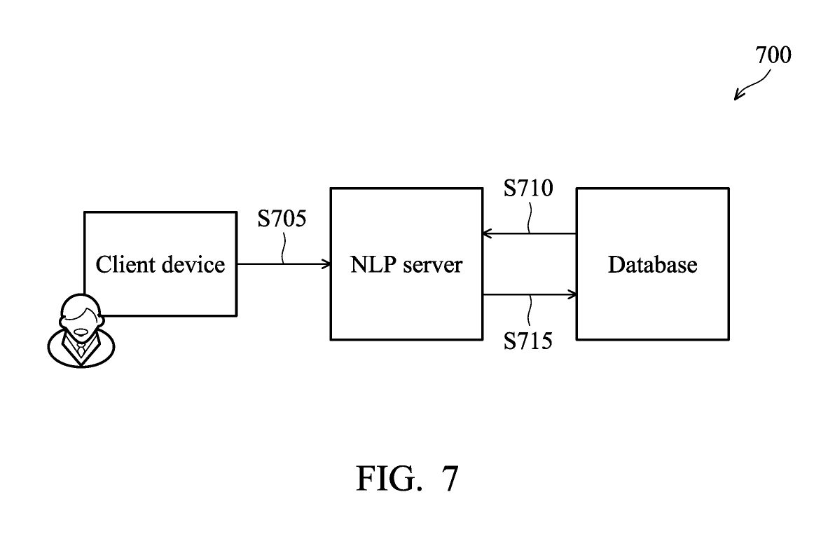

FIG. 7 is a schematic flow diagram of a method 700 illustrating the NLP server processing high-level instructions defined by the user according to an embodiment of the present invention. In the embodiment, the NLP server may provide a webpage for the user to set high-level instructions.

In step S705, the NLP server receives a high-level instruction from the user via the client device. The NLP server extracts a high-level feature code and a content of the high-level instruction, wherein the high-level feature code includes an entity and an action. Next, in step S710, the NLP server queries whether the high-level feature code matches one of the rules related to the high-level feature code in the database, wherein the rules related to the high-level feature code can be used to extract entities and actions from the sentences. In another embodiment, the rules related to the high-level feature code may conform to the grammatical relations between the sentences. For example, the high-level feature code should include a verb and an object, or should include a subject, a predicate and an object. In addition, in step S710, the NLP server also checks whether the content of the high-level instruction matches a rule in the database. In an embodiment, the rule may be one of the rules of the natural language inputs. When the high-level feature code matches one of the rules related to the high-level feature code in the database and the content of the high-level instruction matches one of the rules in the database, in step S715, the NLP server stores the high-level instruction (such as the high-level feature code and the content of the high-level instruction) into the database.

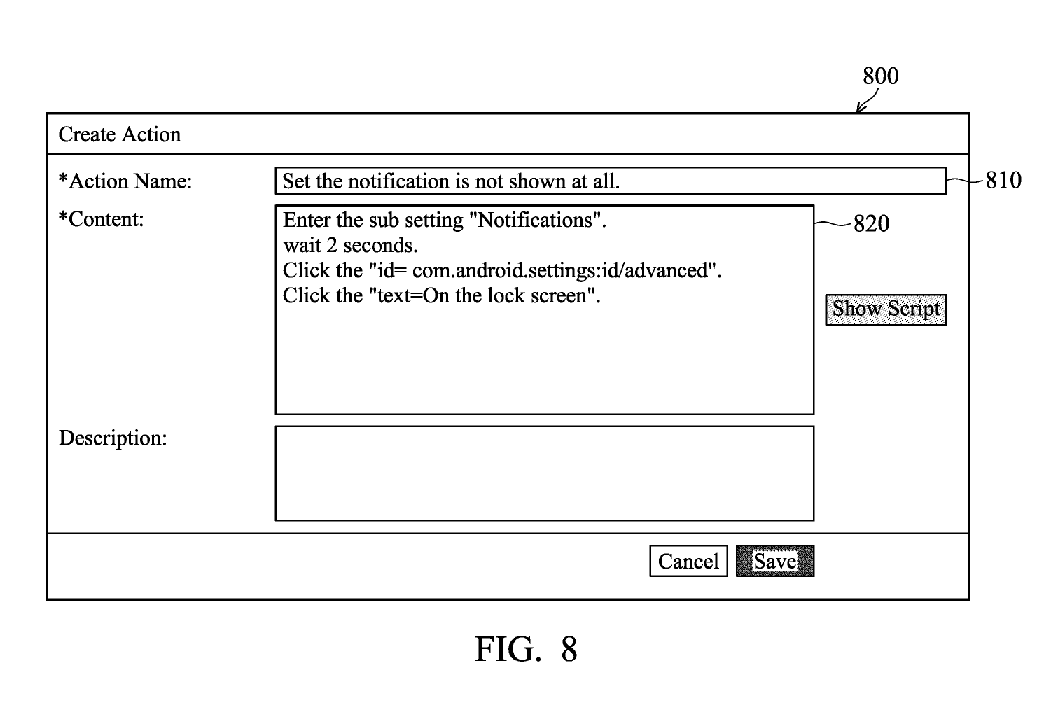

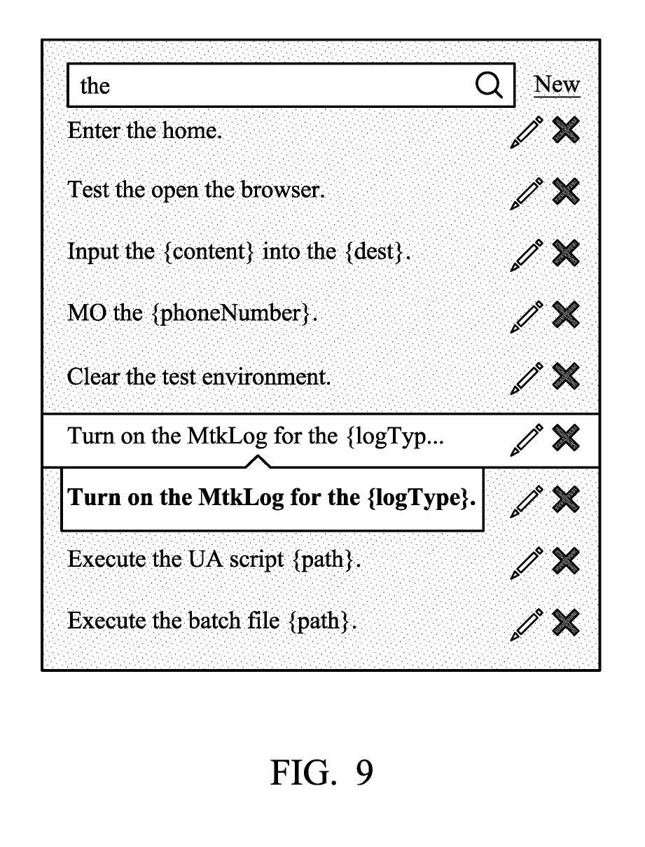

For example, FIG. 8 shows a screen 800 provided by the NLP server for the user to enter the high-level instructions according to an embodiment of the present invention. As shown FIG. 8, the user can enter the action name and content of the high-level instruction which the user want to define in the action name field 810 and the content field 820. The NLP server extracts the high-level feature code and the content of the high-level instruction after receiving the high-level instruction. In the embodiment shown in FIG. 8, the action in the high-level feature code may be “Set the notification is not shown at all.” The entities in the high-level feature code may be such as “Set”, “notification”, “shown” and so on. The content of the high-level instruction may include the content in the content field 820 of FIG. 8. The NLP server queries whether the high-level feature codes match one of the rules related to the high-level feature codes in the database and whether the content matches one of the rules in the database. The NLP server stores the high-level instruction into the database when the high-level feature codes match one of the rules related to the high-level feature codes in the database and the content matches one of the rules in the database. When the user later wants to use the defined high-level instruction, the NLP server may display the action name to the user for query according to the keyword entered by the user, as shown in FIG. 9.

In addition, the processor 124 in the NLP server 120 could execute the programs and instructions in the database 1264 to perform all of the above-described actions and steps or others described herein.

Therefore, the method and the device for processing the natural language provided by the present invention can help users to use the natural language which conforms to the grammatical relations, and can predict the next possible input entered by the user according to the existing natural language inputs so that the efficiency of processing the natural language can be further improved.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present invention. The accompanying method claims present elements of the various steps in a sample order, and are not meant to be limited to the specific order or hierarchy presented.

While the invention has been described by way of example and in terms of exemplary embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for processing natural language, used in an electronic device, comprising:
receiving a natural language input from a user via a client device;
determining whether the natural language input matches a rule in a database;
translating the natural language input into an intermediate code corresponding to the natural language input when the natural language input matches the rule; and
compiling the intermediate code and generating an operation script code corresponding to the intermediate code.

2. The method for processing natural language as claimed in claim 1, wherein after receiving the natural language input, the method further comprises:
querying whether at least one sentence including the natural language input is stored in the database according to the natural language input; and
displaying the sentence to prompt the user when the sentence is stored in the database,
wherein the natural language input is a word.

3. The method for processing natural language as claimed in claim 1, wherein after receiving the natural language input, the method further comprises:
querying whether at least one sentence including the natural language input is stored in the database according to the natural language input;
calculating the probability of occurrence of each sentence when the sentence is stored in the database; and
displaying a first sentence with the highest probability to prompt the user,
wherein the natural language input is a text.

4. The method for processing natural language as claimed in claim 1, wherein the natural language input includes one or more sentences, and the rule conforms to grammatical relations between the sentences.

5. The method for processing natural language as claimed in claim 1, further comprising:
receiving a high-level instruction from the user via the client device;
extracting a high-level feature code of a high-level instruction and a content of the high-level instruction;
determining whether the high-level feature code matches a rule related to the high-level feature code in the database;
determining whether the content of the high-level instruction matches the rule in the database; and
storing the high-level instruction into the database when the high-level feature code matches the rule related to the high-level feature code in the database, and the content of the high-level instruction matches the rule in the database.

6. The method for processing natural language as claimed in claim 1, wherein the natural language inputs entered by the user are stored in the database.

7. The method for processing natural language as claimed in claim 1, wherein the operation script code is executed in an Android operating system.

8. A device for processing natural language, comprising:
a processor; and
a memory, coupled to the processor;
wherein the processor is configured to execute program codes stored in the memory to:
receive a natural language input from a user via a client device;
determine whether the natural language input matches a rule in a database;
translate the natural language input into an intermediate code corresponding to the natural language input when the natural language input matches the rule; and
compile the intermediate code and generate an operation script code corresponding to the intermediate code.

9. The device for processing natural language as claimed in claim 8, wherein after receiving the natural language input, the processor further executes the program codes stored in the memory to:
query whether at least one sentence including the natural language input is stored in the database according to the natural language input; and
display the sentence to prompt the user when the sentence is stored in the database,
wherein the natural language input is a word.

10. The device for processing natural language as claimed in claim 8, wherein after receiving the natural language input, the processor further executes the program codes stored in the memory to:
query whether at least one sentence including the natural language input is stored in the database according to the natural language input;
calculate the probability of occurrence of each sentence when the sentence is stored in the database; and
display a first sentence with the highest probability to prompt the user,
wherein the natural language input is a text.

11. The device for processing natural language as claimed in claim 8, wherein the natural language input includes one or more sentences, and the rule conforms to grammatical relations between the sentences.

12. The device for processing natural language as claimed in claim 8, wherein the processor further executes the program codes stored in the memory to:
receive a high-level instruction from the user via the client device;
extract a high-level feature code of a high-level instruction and a content of the high-level instruction;
determine whether the high-level feature code matches a rule related to the high-level feature code in the database;
determine whether the content of the high-level instruction matches the rule in the database; and
store the high-level instruction into the database when the high-level feature code matches the rule related to the high-level feature code in the database, and the content of the high-level instruction matches the rule in the database.

13. The device for processing natural language as claimed in claim 8, wherein the natural language inputs entered by the user are stored in the database.

14. The device for processing natural language as claimed in claim 8, wherein the operation script code is executed in an Android operating system.
